(19) United States
(12) Patent Application Publication
(10) Pub. No.: US 2025/0299483 A1
(43) Pub. Date: Sep. 25, 2025

(54) INFORMATION PROCESSING SYSTEM AND INFORMATION PROCESSING METHOD

(71) Applicant: Sony Semiconductor Solutions Corporation, Kanagawa (JP)

(72) Inventors: Naoya HANEDA, Kanagawa (JP); Norio YASUDA, Kanagawa (JP); Mikita YASUDA, Kanagawa (JP)

(73) Assignee: Sony Semiconductor Solutions Corporation, Kanagawa (JP)

(21) Appl. No.: 18/864,548

(22) PCT Filed: May 12, 2023
(86) PCT No.: PCT/JP2023/017961

§ 371 Date: Nov. 11, 2024

(30) Foreign Application Priority Data
May 18, 2022 (JP) 2022-081460

(51) Int. Cl. G06V 20/17; H04W 4/029

(52) U.S. Cl. CPC G06V 20/17; H04W 4/029

(57) ABSTRACT

An information processing system, comprising a first processor configured to receive location information indicating a location of a construction vehicle located within a construction site: receive local image data of an area around the construction vehicle. wherein the area around the construction vehicle comprises a portion of the construction site that is less than the entire construction site: generate local three-dimensional (3D) information based on the location information and the local image data: and output the local 3D information to a server: and the server, wherein the server stores global 3D information of the construction site including a topography of the entire construction site and wherein the server is configured to update the global 3D information of the construction site based on the local 3D information output by the first processor.

### CROSS-REFERENCE TO RELATED APPLICATIONS

This application claims the benefit of Japanese Priority Patent Application JP 2022-081460 filed May 18, 2022, which is herein incorporated by reference in its entirety.

### TECHNICAL FIELD

The present disclosure relates to an information processing system and an information processing method.

### BACKGROUND ART

In order to achieve digital transformation (DX) of a construction status of a site in a construction site or the like, there have been proposed systems that generate three-dimensional information regarding a topography of a construction area or a shape of a disposed object. For example, the proposed systems include a system in which each control device provided in a plurality of construction vehicles generates three-dimensional information (three-dimensional data) from imaging data and transmits the generated three-dimensional data to a server device, and the server device integrates pieces of the three-dimensional data with each other (refer to Patent Literature 1, for example). In this system, a server device instructs an imaging range to a control device to generate desired three-dimensional data.

### CITATION LIST

### Patent Literature

[PTL 1] JP 2017-186870 A

### SUMMARY

### Technical Problem

However, the above-described known technique has a problem that processing becomes complicated because each control device separately generates a piece of three-dimensional information.

Therefore, the present disclosure proposes an information processing system and an information processing method that simplify generation of three-dimensional information of a construction area.

### Solution to Problem

An information processing system according to the present disclosure includes: a server device that holds, out of three-dimensional information of a topography of a construction area including a shape of a disposed object, the three-dimensional information of a whole of the construction area, and updates the held three-dimensional information of the whole of the construction area based on local three-dimensional information which is the three-dimensional information of an area where construction work has been conducted by a construction device in the construction area; a first information processing device including a three-dimensional information generation unit that generates the local three-dimensional information based on position information of the construction device and an image of the construction area and including a three-dimensional information transmission unit that transmits the generated local three-dimensional information to the server device; and a second information processing device that generates the position information and transmits the generated position information to the first information processing device.

An information processing method according to the present disclosure includes: holding, out of three-dimensional information of a topography of a construction area including a shape of a disposed object, the three-dimensional information of a whole of the construction area; generating position information of a construction device that conducts construction work in the construction area; generating local three-dimensional information which is the three-dimensional information of an area where the construction work has been conducted by the construction device based on the position information and an image of the construction area; and updating the held three-dimensional information of the whole of the construction area based on the generated local three-dimensional information.

An information processing system, comprising: a first processor configured to: receive location information indicating a location of a construction vehicle located within a construction site; receive local image data of an area around the construction vehicle, wherein the area around the construction vehicle comprises a portion of the construction site that is less than the entire construction site; generate local three-dimensional (3D) information based on the location information and the local image data; and output the local 3D information to a server; and the server, wherein the server stores global 3D information of the construction site including a topography of the entire construction site and wherein the server is configured to update the global 3D information of the construction site based on the local 3D information output by the first processor.

A method for updating global three-dimensional (3D) information of a construction site comprising: receiving location information indicating a location of a construction vehicle located within the construction site; receiving local image data of an area around the construction vehicle, wherein the area around the construction vehicle comprises a portion of the construction site that is less than the entire construction site; generating local 3D information based on the location information and the local image data; transmitting the local 3D information to a server; and updating global 3D information of the construction site including a topography of the entire construction site stored by the server based on the local 3D information transmitted to the server.

At least one non-transitory computer-readable medium having instructions encoded thereon that, when executed by at least one processor, cause the at least one processor to perform a method for updating global three-dimensional (3D) information of a construction site, the method comprising: receiving location information indicating a location of a construction vehicle located within the construction site; receiving local image data of an area around the construction vehicle, wherein the area around the construction vehicle comprises a portion of the construction site that is less than the entire construction site; generating local 3D information based on the location information and the local image data; transmitting the local 3D information to a server; and updating global 3D information of the construction site including a topography of the entire construction site stored by the server based on the local 3D information transmitted to the server.

### BRIEF DESCRIPTION OF DRAWINGS

FIG. 1A is a diagram illustrating a configuration example of an information processing system according to a first embodiment of the present disclosure.

FIG. 1B is a diagram illustrating a configuration example of the information processing system according to the first embodiment of the present disclosure.

FIG. 2 is a diagram illustrating a configuration example of a third information processing device according to the first embodiment of the present disclosure.

FIG. 3 is a diagram illustrating a configuration example of a second information processing device according to the first embodiment of the present disclosure.

FIG. 4 is a diagram illustrating a configuration example of an information processing device according to the first embodiment of the present disclosure.

FIG. 5A is a diagram illustrating an example of processing of construction work information and a construction area according to the first embodiment of the present disclosure.

FIG. 5B is a diagram illustrating an example of processing of construction information and a construction area according to the first embodiment of the present disclosure.

FIG. 5C is a diagram illustrating an example of processing of construction work information and a construction area according to the first embodiment of the present disclosure.

FIG. 6 is a diagram illustrating a configuration example of a server device according to the first embodiment of the present disclosure.

FIG. 7 is a diagram illustrating an example of a processing procedure in the processing of the third information processing device according to the first embodiment of the present disclosure.

FIG. 8 is a diagram illustrating an example of a processing procedure of the processing of the second information processing device according to the first embodiment of the present disclosure.

FIG. 9 is a diagram illustrating an example of a processing procedure in the processing of the information processing device according to the first embodiment of the present disclosure.

FIG. 10 is a diagram illustrating an example of a processing procedure regarding the processing of a server device according to the first embodiment of the present disclosure.

FIG. 11 is a diagram illustrating an example of a processing procedure in the processing of the server device according to the first embodiment of the present disclosure.

FIG. 12 is a diagram illustrating an example of generation of three-dimensional information according to the first embodiment of the present disclosure.

FIG. 13 is a diagram illustrating a configuration example of an information processing device according to a second embodiment of the present disclosure.

FIG. 14 is a diagram illustrating a configuration example of a second information processing device according to a third embodiment of the present disclosure.

FIG. 15 is a diagram illustrating an example of a processing procedure regarding the processing of the second information processing device according to the third embodiment of the present disclosure.

FIG. 16 is a diagram illustrating an example of a processing procedure regarding the processing of the information processing device according to the third embodiment of the present disclosure.

### DESCRIPTION OF EMBODIMENTS

Embodiments of the present disclosure will be described below in detail with reference to the drawings. The description will be given in the following order. Note that, in each of the following embodiments, the same parts are denoted by the same reference symbols, and a repetitive description thereof will be omitted.
1. First embodiment
2. Second embodiment
3. Third embodiment
4. Modifications

### 1. First Embodiment

### Configuration of Information Processing System

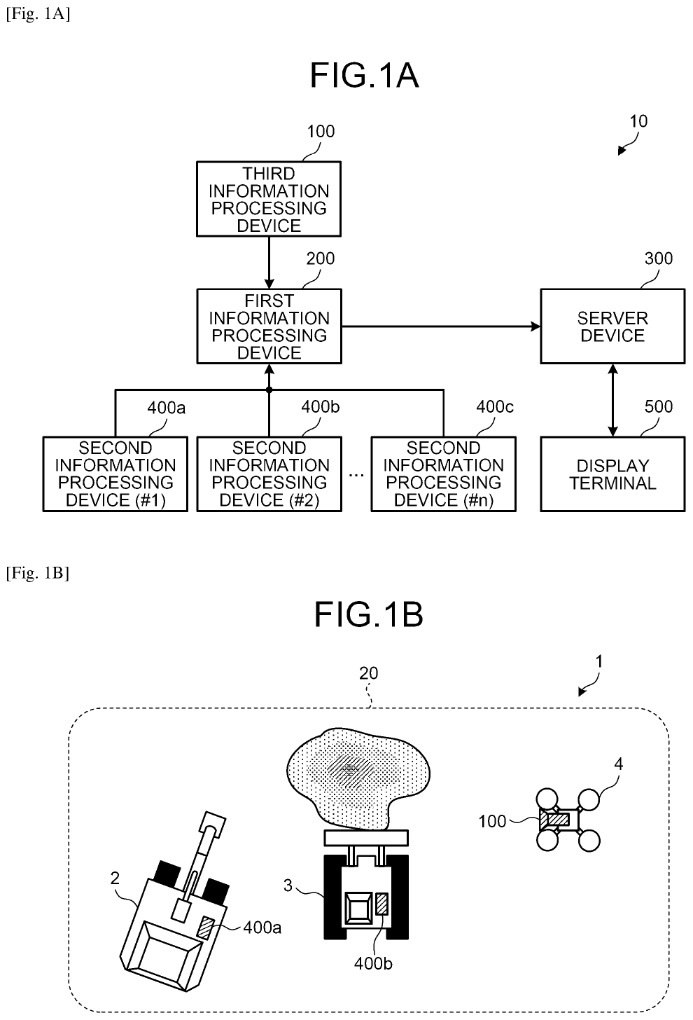

FIGS. 1A and 1B are diagrams illustrating a configuration example of an information processing system according to a first embodiment of the present disclosure. FIG. 1A is a diagram illustrating a configuration example of an information processing system 10 of the present disclosure. The information processing system 10 generates three-dimensional information of a topography of a construction area including a shape of an object disposed at a construction site or the like. Three-dimensional information can be formed by using point cloud data, for example. The information processing system 10 includes a first information processing device 200, a plurality of second information processing devices 400, a third information processing device 100, a server device 300, and a display terminal 500. The information processing system 10 in the drawing illustrates an example of including a second information processing device 400a as well as second information processing device 400b to a second information processing device 400c.

The third information processing device 100 generates an image of the whole of the construction area. The third information processing device 100 is mounted on a device such as an unmanned aerial vehicle, for example, and performs shooting of the construction area from above, thereby generating an image of the whole of the construction area. The third information processing device 100 records the generated image and the position information at the time of shooting. During or after the flight of the unmanned aerial vehicle, the image and the position information are supplied to the first information processing device 200 disposed on the ground via wireless communication, wired communication, or a recording medium such as semiconductor memory.

The second information processing device 400 is mounted on a construction device that conducts construction work in a construction area, and records position information during construction work. During or after the construction work, the position information is supplied to the first information processing device 200 via wireless communication, wired communication, or a recording medium such as semiconductor memory.

Based on the image and the position information supplied from the third information processing device 100 and the position information supplied from the second information processing device 400, the first information processing device 200 generates and records three-dimensional information of the whole of the construction area or a part of the construction area. The first information processing device 200 transmits the recorded three-dimensional information to the server device 300.

The server device 300 holds the three-dimensional information from the first information formation processing device 200 and updates the held three-dimensional information. The server device 300 transmits all or part of the three-dimensional information to the display terminal 500 in response to a request from the display terminal 500.

Based on user's operation, the display terminal 500 displays three-dimensional information on a display device mounted on the terminal. The display terminal 500 acquires three-dimensional information of the whole of the construction area or a part of the construction area from the server device 300 via wireless communication or wired communication, and displays the acquired three-dimensional information. The user can use the display terminal 500 to confirm a progress status of the construction work, enabling utilization for tasks such as budget management.

FIG. 1B is a diagram illustrating a construction site. The drawing is a diagram illustrating an arrangement of the second information processing device 400 and the third information processing device 100 at a construction site 1. The second information processing devices 400a and 400b are disposed in construction vehicles 2 and 3, respectively. The construction vehicles 2 and 3 perform civil engineering work and the like in a construction area 20. The construction vehicles 2 and 3 are assumed to be excavators and bulldozers, respectively. The construction vehicles 2 and 3 are examples of the above-described construction device. The construction vehicles 2 and 3 include a power unit and a control unit. The control unit performs control to travel and construction work on a route instructed by the user. The construction work of the construction vehicle 2 or the like causes a topographical change in the construction area 20. Construction vehicles 2 and 3 may also be referred to herein as construction work vehicles.

The third information processing device 100 is disposed in an unmanned aerial vehicle 4. The unmanned aerial vehicle 4 flies above the construction area 20 and generates an image of the whole of the construction area 20. The unmanned aerial vehicle 4 includes a power unit and a control unit, dedicated for flight. This control unit performs control to achieve flight at an altitude and along a route instructed by a user. Instead of the unmanned aerial vehicle 4, the third information processing device 100 can be disposed at a position where the whole of the construction area can be overlooked, for example, on a roof of a tall building or the like.

### Configuration of Third Information Processing Device

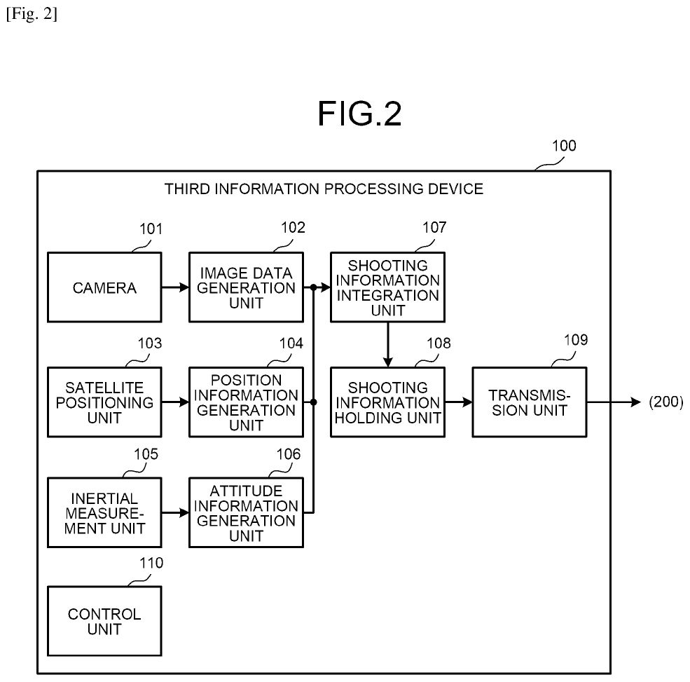

FIG. 2 is a diagram illustrating a configuration example of the third information processing device according to the first embodiment of the present disclosure. The drawing is a block diagram illustrating a configuration example of the third information processing device 100. The third information processing device 100 includes a camera 101, an image data generation unit 102, a satellite positioning unit 103, a position information generation unit 104, an inertial measurement unit 105, an attitude information generation unit 106, a shooting information integration unit 107, and a shooting information holding unit 108. Furthermore, the third information processing device 100 further includes a transmission unit 109 and a control unit 110.

The camera 101 performs shooting of the construction area 20. The camera 101 includes an imaging clement such as a complementary metal oxide semiconductor (CMOS) image sensor, and performs shooting under the control of the control unit 110.

The image data generation unit 102 generates an image based on a shooting result of the camera 101. The image data generation unit 102 generates an image of the whole of the construction area 20. The image data generation unit 102 outputs the generated image to the shooting information integration unit 107.

The satellite positioning unit 103 acquires a position (latitude, longitude, and altitude). The satellite positioning unit 103 includes a global navigation satellite system (GNSS), for example, and acquires a position under the control of the control unit 110. The satellite positioning unit 103 outputs the acquired position to the position information generation unit 104.

The position information generation unit 104 generates position information that is information on the position of the third information processing device 100 based on the position acquired by the satellite positioning unit 103. The position information generation unit 104 outputs the generated position information to the shooting information integration unit 107.

The inertial measurement unit 105 acquires the attitude of the camera 101. The inertial measurement unit 105 includes an inertial measurement unit (IMU), for example, and acquires yaw, pitch, and roll, each representing a three-dimensional rotation amount under the control of the control unit 110. The inertial measurement unit 105 outputs the acquired attitude to attitude information generation unit 106.

The attitude information generation unit 106 generates attitude information of the camera 101 based on the attitude acquired by the inertial measurement unit 105. The attitude information generation unit 106 outputs the generated attitude to the shooting information integration unit 107.

The shooting information integration unit 107 generates shooting information in which the image data, the position information, and the attitude information are integrated together with time information indicating that the pieces of data are synchronized with each other. The shooting information can include, for example, image data, position information, and attitude information for one frame as one file. The shooting information integration unit 107 outputs the generated shooting information to the shooting information holding unit 108.

The shooting information holding unit 108 holds shooting information generated by the shooting information integration unit 107. The shooting information holding unit 108 includes a recording medium such as semiconductor memory or a hard disk, and can hold shooting information generated during the flight of the unmanned aerial vehicle 4.

The transmission unit 109 transmits the shooting information held in the shooting information holding unit 108 to the first information processing device 200. During flight or after landing of the unmanned aerial vehicle 4, the transmission unit 109 can read the shooting information held in the shooting information holding unit 108, and can transmit the read shooting information to the first information processing device 200 via wired communication or wireless communication.

The control unit 110 performs overall control of the third information processing device 100.

### Configuration of Second Information Processing Device

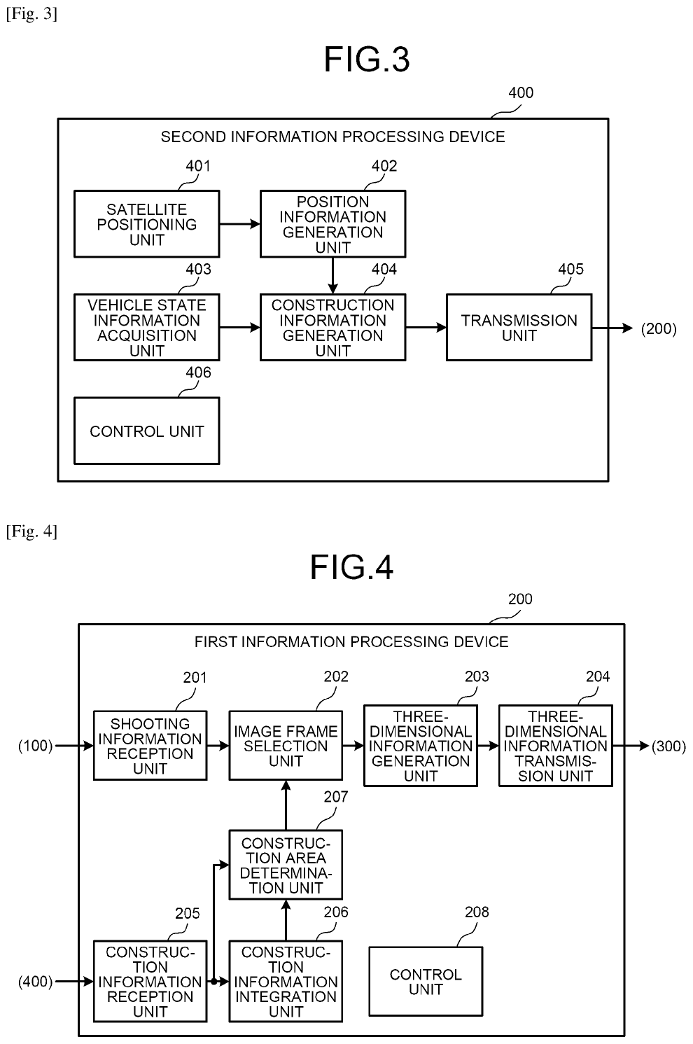

FIG. 3 is a diagram illustrating a configuration example of the second information processing device according to the first embodiment of the present disclosure. The drawing is a block diagram illustrating a configuration example of the second information processing device 400. The second information processing device 400 includes a satellite positioning unit 401, a position information generation unit 402, a vehicle state information acquisition unit 403, a construction work information generation unit 404, a transmission unit 405, and a control unit 406.

The satellite positioning unit 401 acquires a position (latitude, longitude, and altitude) similarly to the satellite positioning unit 103. The satellite positioning unit 401 outputs the acquired position to the position information generation unit 402.

Similarly to the position information generation unit 104, the position information generation unit 402 generates position information that is information on the position of the second information processing device 400 based on the position acquired by the satellite positioning unit 401. The position information generation unit 402 outputs the generated position information to the construction work information generation unit 404.

The vehicle state information acquisition unit 403 acquires vehicle state information indicating an operation state of the construction vehicle 2 and the like. The operation state represents a state of the construction vehicle 2 or the like, such as traveling, stopping, and working. In an excavator, an operation state of a bucket, an arm, or the like corresponds to a working state. In addition, in the bulldozer, an operation state of a blade or the like corresponds to a working state. Of course, by acquiring the construction work information only in a working state of the construction vehicle 2 or the like, it is also possible to obtain construction work information limited to a case where the topographical shape is being changed. The vehicle state information acquisition unit 403 outputs the acquired vehicle state information to the construction work information generation unit 404.

The construction work information generation unit 404 generates and holds, as construction work information, information obtained by adding time information indicating that the position information and the vehicle state information are synchronized with each other.

The transmission unit 405 transmits the construction work information to the first information processing device 200. The transmission unit 405 can transmit the construction work information held by the construction work information generation unit 404 during traveling or after completion of construction work by the construction vehicle 2 or the like.

The control unit 406 performs overall control of the second information processing device 400. Furthermore, the control unit 406 controls the satellite positioning unit 401 to acquire the position and controls the vehicle state information acquisition unit 403 to acquire the vehicle state information. The control unit 406 can perform these controls when a reception unit (not illustrated) has received an acquisition instruction signal. The acquisition instruction signal may be a signal that repeats at a predetermined interval, for example. In this case, the vehicle state information and the like are acquired at predetermined intervals, and the construction work information is generated by the construction work information generation unit 404.

### Configuration of Information Processing Device

FIG. 4 is a diagram illustrating a configuration example of the first information processing device according to the first embodiment of the present disclosure. The drawing is a block diagram illustrating a configuration example of the first information processing device 200. The first information processing device 200 includes a shooting information reception unit 201, an image frame selection unit 202, a construction work information reception unit 205, a construction work information integration unit 206, a construction area determination unit 207, a three-dimensional information generation unit 203, a three-dimensional information transmission unit 204, and a control unit 208.

The shooting information reception unit 201 receives shooting information from the third information processing device 100. The shooting information reception unit 201 outputs the received shooting information to the image frame selection unit 202.

The construction work information reception unit 205 receives construction work information from the second information processing device 400. The construction work information reception unit 205 outputs the received construction work information to the construction work information integration unit 206. In a case where there is one second information processing device 400, the construction work information reception unit 205 outputs the construction work information to the construction area determination unit 207.

The construction work information integration unit 206 integrates construction work information. The construction work information integration unit 206 holds construction work information separately transmitted from the plurality of second information processing devices 400. When all the pieces of construction work information are obtained, the construction work information integration unit 206 outputs these pieces of construction work information to the construction area determination unit 207.

The construction area determination unit 207 determines a construction area where construction work has been conducted by the construction vehicle 2 or the like, out of the construction area 20. This construction area corresponds to an area having a topographical shape changed by the construction vehicle 2 or the like. The construction area determination unit 207 can determine an area in the vicinity of the construction vehicle 2 or the like as a construction area where construction work has been conducted. Specifically, the construction area determination unit 207 can detect an area in the vicinity of the construction vehicle 2 or the like based on the position information included in the construction work information, and can output the detected area as a construction area. The construction area determination unit 207 adds position information to the construction area when outputting the construction area.

When the construction areas of the plurality of construction vehicles are close to each other or overlap each other, the construction area determination unit 207 can determine one area combining the plurality of construction areas, as a construction area. On the other hand, when a construction area is separated from other construction areas, the construction area determination unit 207 determines these construction areas as separate construction areas. The construction area determination unit 207 notifies the image frame selection unit 202 of the construction area of the determination result including its position information.

The construction area determination unit 207 can also narrow down a construction area whose topographical shape has been changed by the construction work of the construction vehicle 2 or the like based on the vehicle state information included in the construction work information. Specifically, the construction area determination unit 207 can detect an area where the vehicle state information of the construction vehicle 2 or the like indicates a working state in the construction area based on the position information described above, and can output the detected area to the image frame selection unit 202.

Based on the construction area output from the construction area determination unit 207, the image frame selection unit 202 selects shooting information necessary for generating three-dimensional information from among pieces of shooting information supplied from the shooting information reception unit 201. For example, when the position information included in the received shooting information is included in the range of the construction area notified from the construction area determination unit 207, the image frame selection unit 202 selects an image frame including the shooting information, as shooting information for generating three-dimensional information of the construction area. Here, the image frame is an image of an area obtained by dividing the image of the whole of the construction area 20. The image frame selection unit 202 supplies the selected image frame to the three-dimensional information generation unit 203.

On the other hand, when the construction area is not notified from the construction area determination unit 207, the image frame selection unit 202 selects all the image frames and supplies the selected image frames to the three-dimensional information generation unit 203. For example, when the construction area is shot for the first time, the three-dimensional information (also referred to herein as global three-dimensional information) is generated using all the shooting information acquired by the third information processing device 100. In this case, since the construction area determination unit 207 does not notify the construction area, the image frame selection unit 202 selects all the image frames and supplies the selected image frames to the three-dimensional information generation unit 203.

The three-dimensional information generation unit 203 generates local three-dimensional information, which is three-dimensional information of an area where construction work has been conducted by the construction vehicle 2 or the like that performs construction work in the construction area 20, based on the construction work information and an image of the construction area. Specifically, the three-dimensional information generation unit 203 generates local three-dimensional information from the shooting information supplied from the image frame selection unit 202. When the construction area is shot for the first time, the three-dimensional information generation unit 203 generates global three-dimensional information of the whole of the construction area 20 instead of the local three-dimensional information. The three-dimensional information generation unit 203 can generate three-dimensional information based on point cloud data. This point cloud data can be generated by a Structure from Motion (SfM) method, for example. The three-dimensional information generation unit 203 outputs the generated global three-dimensional information of the whole of the construction area 20 and the generated local three-dimensional information to the three-dimensional information transmission unit 204.

In this manner, the three-dimensional information generation unit 203 can generate three-dimensional information exclusively for the construction area 20. In addition, the three-dimensional information generation unit 203 first generates global three-dimensional information of the whole of the construction area 20, and then generates local three-dimensional information. The local three-dimensional information is an area having the topographical shape highly likely to have been changed by the construction vehicle 2 or the like. This makes it possible to reduce the processing time as compared with the case of generating the three-dimensional information of the whole of the construction area 20.

The three-dimensional information transmission unit 204 transmits three-dimensional information to the server device 300. The three-dimensional information transmission unit 204 can transmit three-dimensional information via wired communication or wireless communication.

The control unit 208 performs overall control of the first information processing device 200.

### Processing of Construction Work Information and Construction Area

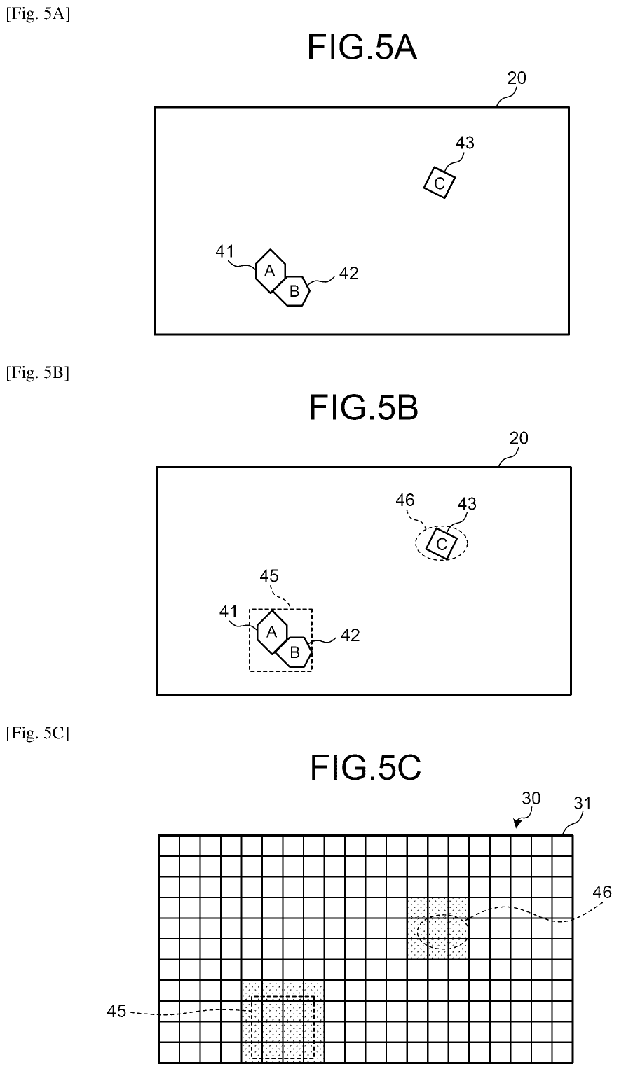

FIGS. 5A to 5C are diagrams illustrating an example of processing of construction work information and a construction area according to the first embodiment of the present disclosure. The drawing is a diagram illustrating processing performed by the construction work information integration unit 206 and the construction area determination unit 207.

FIG. 5A is a diagram illustrating processing performed by the construction work information integration unit 206. The drawing is a diagram illustrating an example in which three construction vehicles (A-C) perform construction work in the construction area 20 in areas 41 to 43, respectively. The construction work information integration unit 206 waits until the construction work information regarding the areas 41 to 43 is transmitted from the second information processing device 400 disposed in each construction vehicle. When the construction work information of the areas 41 to 43 is received, the construction work information integration unit 206 outputs the construction work information to the construction area determination unit 207.

FIG. 5B is a diagram illustrating an example of determination of the construction area by the construction area determination unit 207. As described above, the construction area determination unit 207 combines construction areas overlapping or close to each other. In the drawing, the construction area determination unit 207 combines the areas 41 and 42 being close to each other, and outputs a construction area 45 (dashed rectangle) including the combined areas, as a determination result. In addition, the construction area determination unit 207 outputs a construction area 46 (dashed circle) including an area 43 separated from other areas, as a determination result. Although any shape can be used for the construction area, forming the construction area into a rectangular shape or a circular shape makes it possible to simplify inside-outside determination processing.

FIG. 5C is a diagram illustrating an example of selection of an image frame by the image frame selection unit 202. This illustrates construction areas 45 and 46 in an image 30 representing the whole of the construction area 20. The image 30 is divided into a plurality of image frames 31. The image frame selection unit 202 selects an image frame 31 including the construction areas 45 and 46. The hatched area in the drawing represents the area of the image frame 31 selected by the image frame selection unit 202.

### Configuration of Server Device

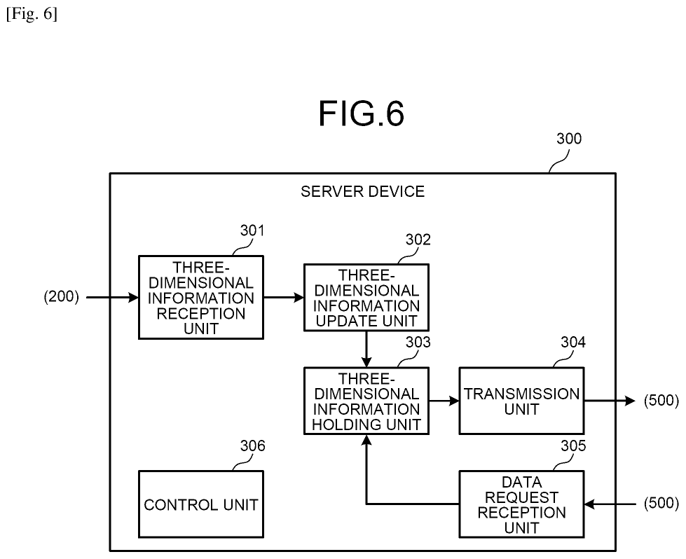

FIG. 6 is a diagram illustrating a configuration example of a server device according to the first embodiment of the present disclosure. The drawing is a block diagram illustrating a configuration example of the server device 300. The server device 300 includes a three-dimensional information reception unit 301, a three-dimensional information update unit 302, a three-dimensional information holding unit 303, a transmission unit 304, a data request reception unit 305, and a control unit 306.

The three-dimensional information reception unit 301 receives three-dimensional information from the first information processing device 200. The three-dimensional information reception unit 301 outputs the received three-dimensional information to the three-dimensional information update unit 302.

The three-dimensional information update unit 302 updates three-dimensional information held in the three-dimensional information holding unit 303 described below. This update is a process of referring to the three-dimensional information held in the three-dimensional information holding unit 303 and replacing the past three-dimensional information with newly received three-dimensional information. This update process can be performed based on the position information included in the received three-dimensional information. Specifically, the update process can be performed when the past three-dimensional information exists at the position indicated by the position information included in the received three-dimensional information. In contrast, when the past three-dimensional information does not exist at the position indicated by the received three-dimensional information, the three-dimensional information update unit 302 performs a process of adding the received three-dimensional information. This makes it possible to maintain the three-dimensional information of the whole of the construction area 20 in the latest state.

The three-dimensional information holding unit 303 holds three-dimensional information of the whole of the construction area 20. The three-dimensional information holding unit 303 adds or updates the held three-dimensional information under the control of the three-dimensional information update unit 302. For example, when no three-dimensional information is held, such as a case where shooting of the construction area is performed for the first time, all pieces of three-dimensional information are recorded and held.

The data request reception unit 305 receives a three-dimensional information request from the display terminal 500. Based on the received three-dimensional information request, the data request reception unit 305 instructs the three-dimensional information holding unit 303 to output three-dimensional information.

The transmission unit 304 transmits the three-dimensional information output from the three-dimensional information holding unit 303 to the display terminal 500.

The control unit 306 performs overall control of the server device 300.

When the data request reception unit 305 has received a request for three-dimensional information from the display terminal 500, the control unit 306 performs control to read three-dimensional information regarding the requested position from the three-dimensional information holding unit 303. The read three-dimensional information is supplied to the transmission unit 304. The transmission unit 304 transmits the three-dimensional information supplied from the three-dimensional information holding unit 303 to the display terminal 500 via wired communication or wireless communication. This makes it possible to browse the three-dimensional information regarding the whole of the construction area or a certain position on the display terminal 500.

### Processing of Third Information Processing Device

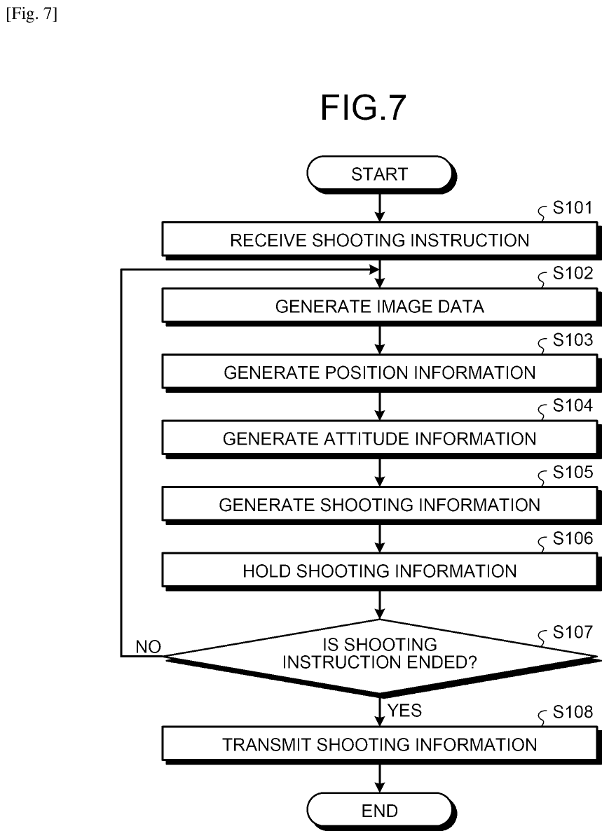

FIG. 7 is a diagram illustrating an example of a processing procedure regarding the processing of the third information processing device according to the first embodiment of the present disclosure. The drawing is a flowchart illustrating an example of a processing procedure regarding the processing of the third information processing device 100.

When the control unit 110 of the third information processing device 100 receives a shooting instruction instructing timing to acquire shooting information (step S101), the camera 101 performs shooting, and the image data generation unit 102 generates image data (step S102). At this time, data volume can be reduced by encoding the image data. Next, the satellite positioning unit 103 acquires a position, and the position information generation unit 104 generates position information (step S103). Here, the position information includes latitude, longitude, and altitude, for example. Next, the inertial measurement unit 105 acquires the attitude, and the attitude information generation unit 106 generates attitude information (step S104). Here, the attitude information includes, for example, rotation vectors of three axes calculated from acceleration and angular velocity of the unmanned aerial vehicle 4.

Next, the shooting information integration unit 107 integrates the image data, the position information, and the attitude information to generate shooting information (step S105). Next, the shooting information holding unit 108 holds the shooting information formation in a medium or the like (step S106). Next, the control unit 110 determines whether the shooting instruction has ended (step S107). As a result, in a case where the shooting instruction has not ended (step S107, No), the control unit 110 returns to the processing of step S102.

In contrast, in step S107, in a case where the shooting instruction is ended (step S107, Yes), the transmission unit 109 transmits the shooting information to the first information processing device 200 (step S108), and ends the processing. Note that the timing of transmitting shooting information to the first information processing device 200 can be set to a timing immediately after generation of the shooting information in step S105, for example. In this case, the shooting information is transmitted to a stationary station during the flight of the unmanned aerial vehicle 4, making it possible to eliminate the need for the transmission of the shooting information after landing. Note that the processing in steps S102 to S104 is not limited to the order in the drawing.

### Processing of Second Information Processing Device

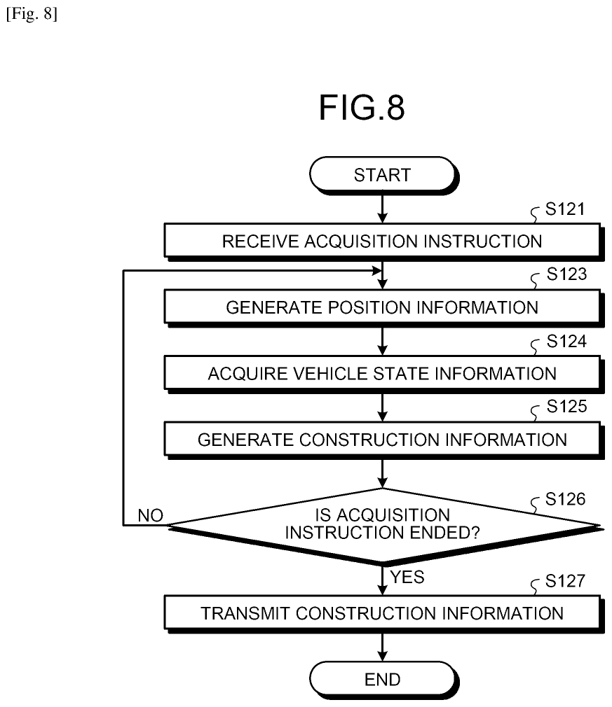

FIG. 8 is a diagram illustrating an example of a processing procedure of the processing of the second information processing device according to the first embodiment of the present disclosure. The drawing is a flowchart illustrating an example of a processing procedure regarding the processing of the second information processing device 400.

When the control unit 406 of the second information processing device 400 has received an acquisition instruction instructing the timing of acquiring construction work information (step S121), the satellite positioning unit 401 acquires the position, and the position information generation unit 402 generates the position information (step S123). Here, the position information includes latitude, longitude, and altitude, for example. Next, the vehicle state information acquisition unit 403 acquires vehicle state information (step S124). Here, the vehicle state information corresponds to, for example, information indicating whether the construction vehicle 2 or the like is traveling or stopped, information indicating whether a bucket or a blade provided in the construction vehicle 2 or the like is being operated or stopped, and the like. These pieces of information can also be acquired by automatic recognition by a separately installed camera.

Next, the construction work information generation unit 404 generates construction work information (step S125). At this time, based on the position information and the vehicle state information, the construction work information generation unit 404 generates construction work information, also referred to herein as work information, indicating an area where a substantial construction work accompanied by a topographical shape change has been performed. For example, by excluding the position information in a state where the bucket or the blade of the construction vehicle 2 or the like is stopped and generating the construction work information using the position information for the position where the bucket or the blade is operating, the construction work information generation unit 404 can generate construction work information indicating the construction area where the topographical shape has been changed. Next, the control unit 406 determines whether the acquisition instruction has ended (step S126). As a result, in a case where the acquisition instruction has not ended (step S126, No), the control unit 406 returns to the processing of step S123.

In contrast in step S126, in a case where the acquisition instruction has ended (step S126, Yes), the transmission unit 405 transmits the construction work information to the first information processing device 200 (step S127), and ends the processing. Note that the timing of transmitting construction work information to the first information processing device 200 can be set to a timing immediately after generation of the construction work information in step S125, for example. In this case, the construction work information is transmitted to the first information processing device 200 during construction work, making it possible to eliminate the need to transmit the construction work information after completion of the construction work. Note that the processing in steps S123 and S124 is not limited to the order in the drawing.

### Processing of Information Processing Device

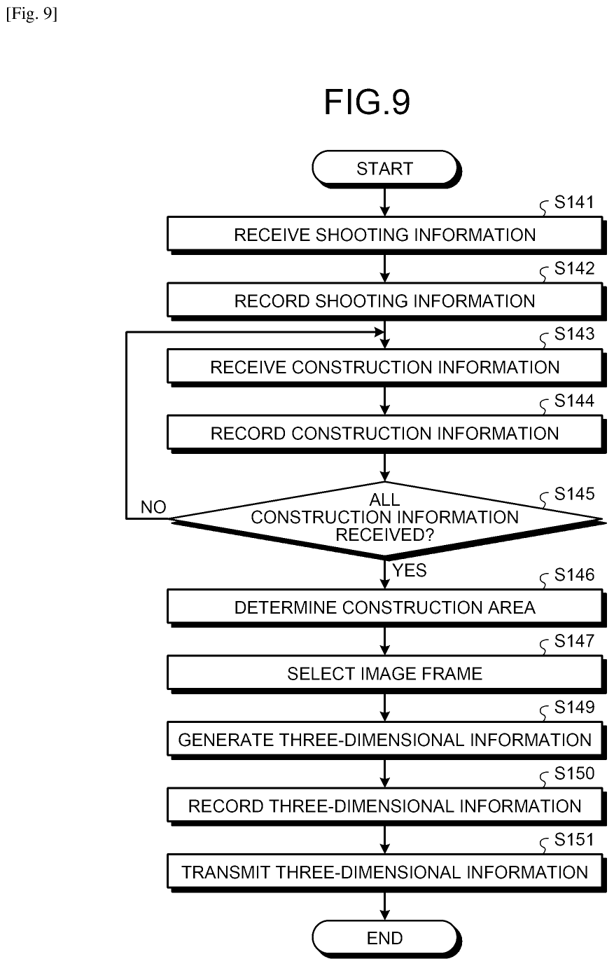

FIG. 9 is a diagram illustrating an example of a processing procedure regarding the processing of the first information processing device according to the first embodiment of the present disclosure. The drawing is a flowchart illustrating an example of a processing procedure regarding the processing of the first information processing device 200.

First, the shooting information reception unit 201 receives shooting information (step S141). The received shooting information is recorded in a recording medium (not illustrated in FIG. 4) built in the first information processing device 200 (step S142). Note that, in a case where the shooting information is acquired from the external recording medium, read processing from the recording medium is performed, and the read shooting information is recorded in the recording medium built in the first information processing device 200 in step S142.

Next, the construction work information reception unit 205 receives the construction work information (step S143). Next, the construction work information is recorded in the above-described recording medium (step S144). Next, the control unit 208 determines whether all the construction work information has been received (step S145). As a result, when not all the pieces of construction work information have been received (step S145, No), the control unit 208 returns to the processing of step S143.

In contrast, when all the construction work information has been received in step S145 (step S145, Yes), the construction area determination unit 207 determines the construction area (step S146). This determination obtains a construction area including an area whose topographical shape has been changed, by using all the construction work information. For example, when there are overlapping construction areas of the plurality of construction vehicles, one area combining the plurality of construction areas is determined as a construction area based on the position information included in the construction work information. In contrast, when there are no overlapping construction areas, the construction areas are determined as separate construction areas.

Next, the image frame selection unit 202 selects an image frame included in the shooting information (step S147). That is, when the position information included in the shooting information is within the range of the construction area, the image frame selection unit 202 selects the image frame corresponding to the position information, as an image frame for generating the three-dimensional information. Next, the three-dimensional information generation unit 203 generates three-dimensional information based on the selected image frame (step S149). This leads to generation of three-dimensional information of the whole of the construction area 20 or local three-dimensional information of the construction area 20.

Next, the generated three-dimensional information is recorded in the recording medium (step S150), and the three-dimensional information transmission unit 204 transmits the three-dimensional information to the server device 300 (step S151). The timing of transmitting the three-dimensional information can be a timing after the generation process of the three-dimensional information in step S149 is completed for all the shooting information. Alternatively, the three-dimensional information can be transmitted every time the generation process of the three-dimensional information in step S149 is completed for a part of the shooting information.

### Processing of Server Device

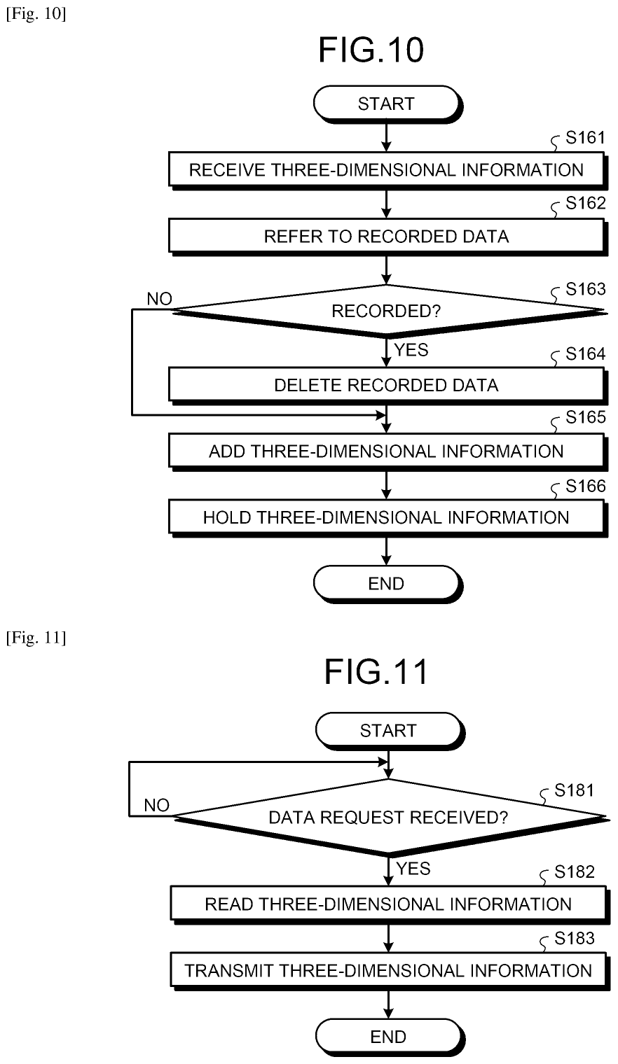

FIG. 10 is a diagram illustrating an example of a processing procedure regarding the processing of the server device according to the first embodiment of the present disclosure. The drawing is a flowchart illustrating an example of a processing procedure regarding the processing when receiving three-dimensional information in the server device 300.

First, the three-dimensional information reception unit 301 receives three-dimensional information (step S161). Next, the three-dimensional information update unit 302 refers to the recorded data of the three-dimensional information holding unit 303 (step S162), and determines whether the past three-dimensional information of the same construction area as the received three-dimensional information has been recorded. As a result, when the three-dimensional information of the same construction area is not recorded (step S163, No), the process proceeds to step S165. In contrast, when the three-dimensional information of the same construction area has been recorded (step S163, Yes), the three-dimensional information update unit 302 deletes the recorded data of the area (step S164), and proceeds to the process of step S165.

In step S165, the three-dimensional information update unit 302 adds the three-dimensional information to the three-dimensional information holding unit 303 (step S165). As a result, the three-dimensional information of the whole of the construction area 20 or local three-dimensional information of the area is held in the three-dimensional information holding unit 303 (step S166). Thereafter, the process ends. Note that the processes of steps S164 and S165 described above update the three-dimensional information.

FIG. 11 is a diagram illustrating an example of a processing procedure in the processing of the server device according to the first embodiment of the present disclosure. The drawing is a flowchart illustrating an example of a processing procedure regarding the processing when a data request has been received in the server device 300.

When the data request reception unit 305 has received a data request from the display terminal 500 (step S181, Yes), the three-dimensional information corresponding to the requested construction area is read from the three-dimensional information holding unit 303 (step S182). Next, the read three-dimensional information is transmitted by the transmission unit 304 (step S183). Thereafter, the process ends.

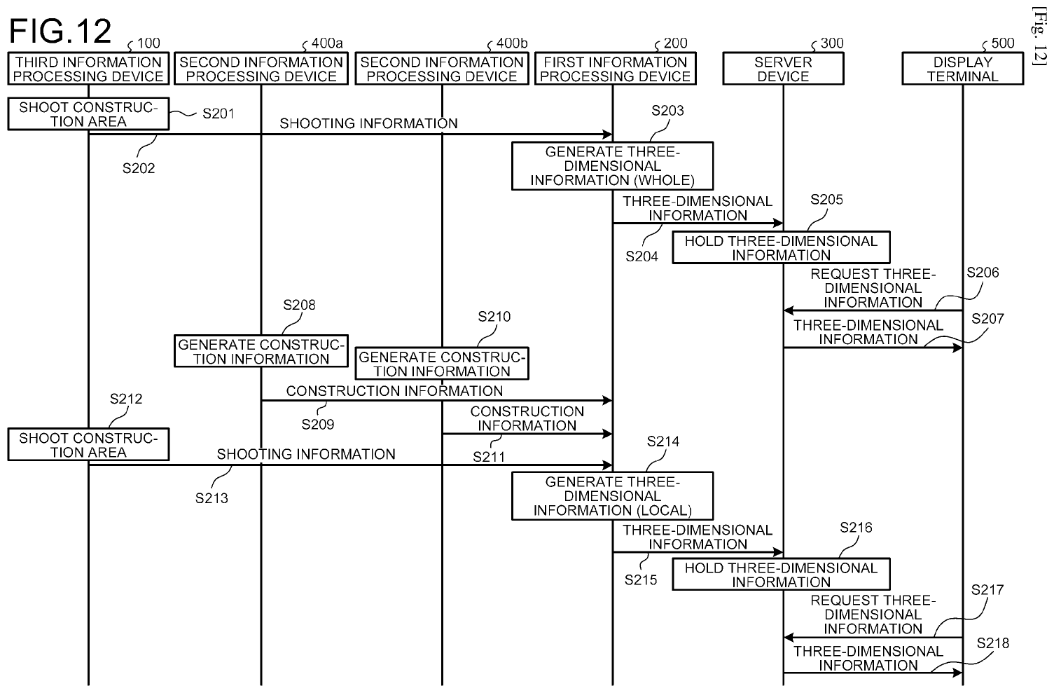

FIG. 12 is a diagram illustrating an example of generation of three-dimensional information according to the first embodiment of the present disclosure. The drawing is a sequence diagram illustrating processing in the third information processing device 100, the second information processing device 400a, the second information processing device 400b, the first information processing device 200, the server device 300, and the display terminal 500.

First, the third information processing device 100 performs shooting of the construction area (step S201). Next, the third information processing device 100 transmits shooting information to the first information processing device 200 (step S202). Next, based on the transmitted shooting information, the first information processing device 200 generates three-dimensional information of the whole of the construction area 20 (step S203). Next, the first information processing device 200 transmits the generated three-dimensional information to the server device 300 (step S204). Next, the server device 300 holds the transmitted three-dimensional information (step S205). This three-dimensional information corresponds to the first three-dimensional information. Next, after the display terminal 500 transmits the three-dimensional information request to the server device 300 (step S206), the server device 300 transmits the three-dimensional information to the display terminal 500 (step S207).

On the other hand, the second information processing device 400a generates construction work information (step S208), and transmits the generated construction work information to the first information processing device 200 (step S209). In addition, the second information processing device 400b generates construction work information (step S210), and transmits the generated construction work information to the first information processing device 200 (step S211).

Thereafter, the third information processing device 100 shoots an image of the construction area again (step S212), and transmits shooting information to the first information processing device 200 (step S213). Then, the first information processing device 200 generates local three-dimensional information (step S214) and transmits the generated local three-dimensional information to the server device 300 (step S215). The server device 300 holds the received local three-dimensional information in the three-dimensional information holding unit 303 (step S216). At this time, the server device 300 updates the three-dimensional information held in the three-dimensional information holding unit 303 with the local three-dimensional information.

Thereafter, the display terminal 500 transmits a three-dimensional information request to the server device 300 at a certain timing (step S217), and the server device 300 transmits the three-dimensional information to the display terminal 500 (step S218).

The process in the drawing illustrates a case of generating the three-dimensional information of the whole of the construction area 20 by the construction area shooting at the first time, and updating, at the second time, the three-dimensional information of the area where the topographical shape has actually been changed in the construction area 20. However, the timing of generating the three-dimensional information of the whole of the construction area 20 is not limited to the first time. For example, the three-dimensional information can be generated periodically such as weekly or monthly, or can be generated after bad weather such as rain or a typhoon.

In this manner, in the information processing system 10 according to the first embodiment of the present disclosure, the three-dimensional information generation unit 203 of the first information processing device 200 first generates three-dimensional information of the whole of the construction area 20, and then generates local three-dimensional information exclusively for the construction area where the construction vehicle 2 or the like has conducted construction work. By updating the three-dimensional information of the whole of the construction area 20 based on the local three-dimensional information, it is possible to reduce the processing time as compared with the case of generating the three-dimensional information of the whole of the construction area 20. In addition, since the local three-dimensional information is transmitted to the server device 300, it is possible to reduce the communication data volume, leading to reduction of the communication time. Furthermore, by recording the local three-dimensional information, it is possible to record the history with a smaller data volume than in a case of recording the three-dimensional information of the whole of the construction area 20. Furthermore, since the second information processing device 400 does not generate the three-dimensional information, the processing of the second information processing device 400 can be simplified.

### 2. Second Embodiment

The first information processing device 200 according to the first embodiment described above transmits the generated three-dimensional information to the server device 300. In contrast, a first information processing device 200 according to a second embodiment of the present disclosure is different from the above-described first embodiment in selecting three-dimensional information to be transmitted to the server device 300.

### Configuration of Information Processing Device

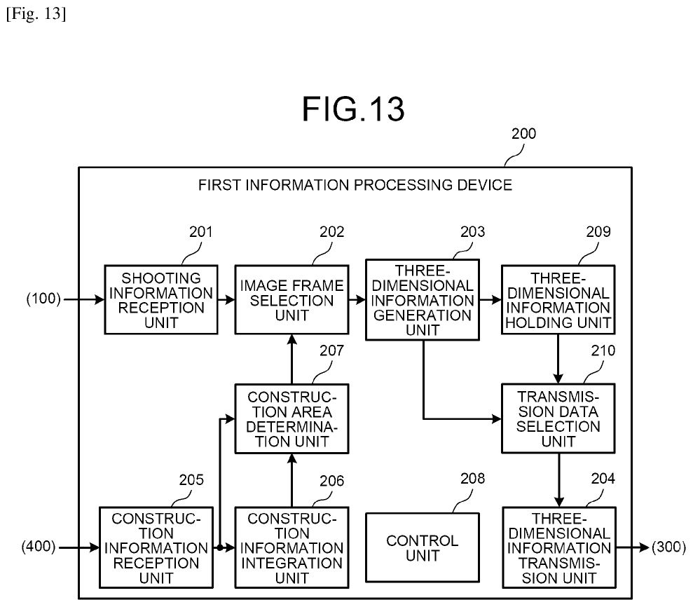

FIG. 13 is a diagram illustrating a configuration example of a first information processing device according to a second embodiment of the present disclosure. The drawing is a diagram illustrating a configuration example of the first information processing device 200, similarly to FIG. 4. The first information processing device 200 in the drawing is different from the first information processing device 200 in FIG. 4 in further including a three-dimensional information holding unit 209 and a transmission data selection unit 210.

The three-dimensional information holding unit 209 records and accumulates three-dimensional information generated by the three-dimensional information generation unit 203, and holds the three-dimensional information of the whole of the construction area 20.

The transmission data selection unit 210 selects three-dimensional information to be transmitted to the server device 300. The transmission data selection unit 210 compares the local three-dimensional information generated by the three-dimensional information generation unit 203 with three-dimensional information of the corresponding area of the three-dimensional information held in the three-dimensional information holding unit 209, and selects the local three-dimensional information having a difference exceeding a predetermined threshold. The local three-dimensional information selected by the transmission data selection unit 210 is transmitted to the server device 300 via the three-dimensional information transmission unit 204. Note that the transmission data selection unit 210 is an example of a selection unit.

In this manner, by holding the three-dimensional information finally transmitted to the server device 300 in the three-dimensional information holding unit 209, it is possible to detect a difference from the three-dimensional information generated thereafter.

The configuration of the information processing system 10 other than this is similar to the configuration of the information processing system 10 according to the first embodiment of the present disclosure, and thus the description thereof will be omitted.

In this manner, the information processing system 10 according to the second embodiment of the present disclosure holds the generated three-dimensional information, selects the local three-dimensional information based on the held three-dimensional information, and transmits the local three-dimensional information to the server device 300. This makes it possible to further reduce data transmission processing.

### 3. Third Embodiment

In the information processing system 10 according to the first embodiment described above, the second information processing device 400 transmits the construction work information including the position information to the first information processing device 200. In comparison, an information processing system 10 according to a third embodiment of the present disclosure is different from the above-described first embodiment in that a second information processing device 400 further transmits an image to the first information processing device 200.

### Configuration of Second Information Processing Device

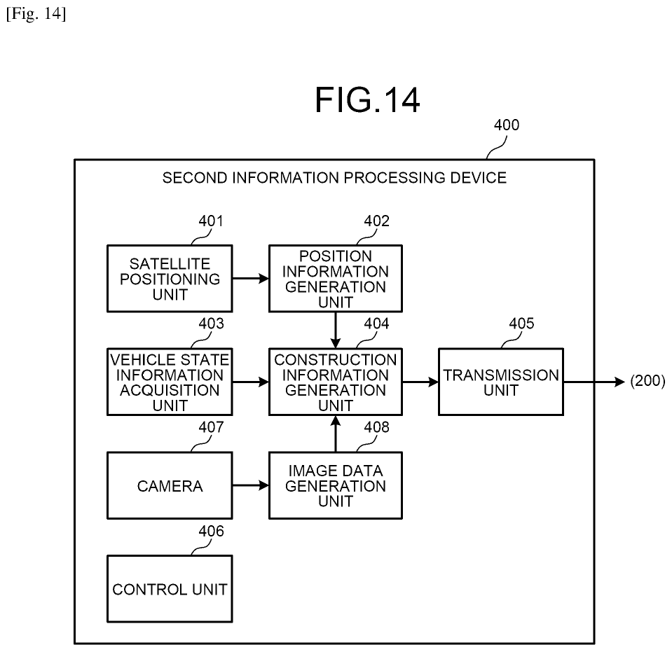

FIG. 14 is a diagram illustrating a configuration example of a second information processing device according to the third embodiment of the present disclosure. The drawing is a diagram illustrating a configuration example of the second information processing device 400, similarly to FIG. 3. The second information processing device 400 in the drawing is different from the second information processing device 400 in FIG. 3 in further including a camera 407 and an image data generation unit 408.

Similarly to the camera 101 of the third information processing device 100, the camera 407 performs shooting of the construction area 20.

Similarly to the image data generation unit 102 of the third information processing device 100, the image data generation unit 408 generates an image based on the shooting result of the camera 407. The image data generation unit 408 generates an image of the vicinity of the construction vehicle 2 or the like. The image data generation unit 408 outputs the data of the generated image to the construction work information generation unit 404.

The construction work information generation unit 404 in the drawing generates and holds construction work information, which is information including acquired image data, position information, and vehicle state information as well as additional information being time information indicating synchronization of these pieces of information.

Note that the camera 407 and the image data generation unit 408 can also be formed with a general-purpose portable terminal or a tablet terminal, for example. An image including time information acquired by these terminals, for example, a Joint Photographic Experts Group (JPEG) file, can be included in the construction work information and transmitted to the first information processing device 200.

### Processing of Second Information Processing Device

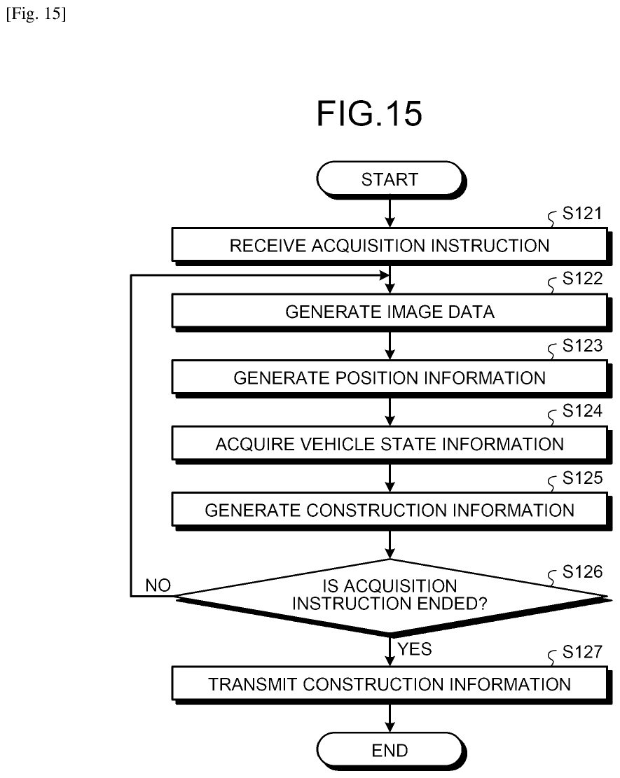

FIG. 15 is a diagram illustrating an example of a processing procedure of the processing of the second information processing device according to the third embodiment of the present disclosure. The drawing is a flowchart illustrating an example of a processing procedure regarding the processing of the second information processing device 400, similarly to FIG. 8.

When the control unit 406 of the second information processing device 400 has received the acquisition instruction instructing the timing of acquiring construction work information (step S121), the camera 407 performs shooting, and the image data generation unit 408 generates image data (step S122). Furthermore, the satellite positioning unit 401 acquires a position, and the position information generation unit 402 generates position information (step S123). Next, the vehicle state information acquisition unit 403 acquires vehicle state information (step S124).

Next, the construction work information generation unit 404 generates construction work information (step S125). Based on the position information, the vehicle state information, and the image data, the construction work information generation unit 404 generates construction work information indicating an area where a substantial construction work accompanied by a topographical shape change has been conducted. Next, the control unit 406 determines whether the acquisition instruction has ended (step S126). As a result, in a case where the acquisition instruction has not ended (step S126, No), the control unit 406 returns to the processing of step S122.

In contrast in step S126, in a case where the acquisition instruction has ended (step S126, Yes), the transmission unit 405 transmits the construction work information including the image data to the first information processing device 200 (step S127), and ends the processing. Note that the timing of transmitting construction work information to the first information processing device 200 can be set to a timing immediately after generation of the construction work information in step S125, for example. In this case, the construction work information is transmitted to the first information processing device 200 during construction work, making it possible to eliminate the need to transmit the construction work information after completion of the construction work. Note that the processing in steps S122 to S124 is not limited to the order in the drawing.

### Processing of Information Processing Device

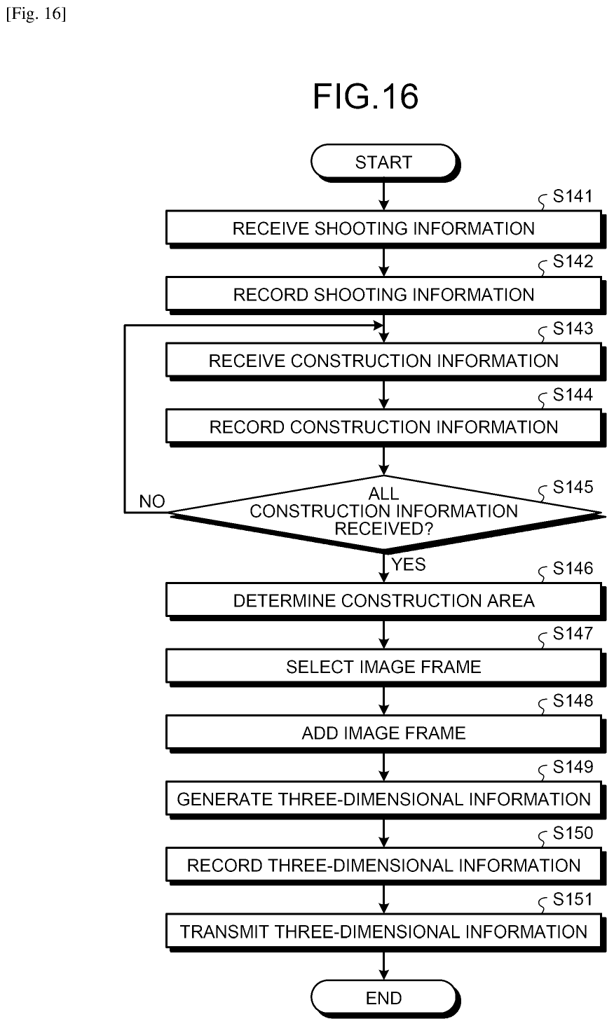

FIG. 16 is a diagram illustrating an example of a processing procedure regarding the processing of the first information processing device according to the third embodiment of the present disclosure. The drawing is a flowchart illustrating an example of a processing procedure regarding the processing of the first information processing device 200, similarly to FIG. 9. The processing procedure in the drawing is different from the processing procedure of FIG. 9 in that the processing of step S148 is added.

As described above, the construction work information received by the first information processing device 200 from the second information processing device 400 includes image data. In step S148, the image frame selection unit 202 adds an image frame including all image data included in the construction work information to the image frame selected in step S147. Next, the three-dimensional information generation unit 203 generates three-dimensional information from the image frame selected from the shooting information and the image frame included in the construction work information (step S148). Since the processing procedure other than this is similar to the processing procedure of FIG. 9, the description thereof is omitted.

The configuration of the information processing system 10 other than this is similar to the configuration of the information processing system 10 according to the first embodiment of the present disclosure, and thus the description thereof will be omitted.

In this manner, in the information processing system 10 according to the third embodiment of the present disclosure, the second information processing device 400 generates an image of a vicinity of the construction vehicle 2 or the like and transmits the generated image to the first information processing device 200 together with the position information. The first information processing device 200 generates three-dimensional information based on the image of the vicinity of the construction vehicle 2 or the like generated by the second information processing device 400 in addition to the image of the whole of the construction area 20 generated by the third information processing device 100. This makes it possible to improve the accuracy of the three-dimensional information.

### 4. Modifications

In the information processing system 10 according to the first embodiment described above, the third information processing device 100 generates an image of the whole of the construction area 20 by shooting the construction area 20. Alternatively, the third information processing device 100 may be controlled to shoot an area where the construction vehicle 2 or the like has conducted construction work.

Specifically, the construction area determined by the construction area determination unit 207 of the first information processing device 200 is transmitted to the third information processing device 100. The third information processing device 100 receives the information of the construction area from the first information processing device 200, and performs flight control of the unmanned aerial vehicle 4 so as to cover the received construction area, and shoots the area by the camera 101 to acquire an image. The shooting information integration unit 107 generates shooting information based on the image and transmits the generated shooting information to the first information processing device 200. The first information processing device 200 generates local three-dimensional information based on the transmitted shooting information. This makes it possible to omit the processing by the image frame selection unit 202 in the first information processing device 200.

The configuration of the information processing system 10 other than this is similar to the configuration of the information processing system 10 according to the first embodiment of the present disclosure, and thus the description thereof will be omitted.

In this manner, in the information processing system 10 according to the modification of the present disclosure, the third information processing device 100 generates the image of the area where the construction work in the vicinity of the construction vehicle 2 or the like has been conducted, making it possible to omit the process of generating the local three-dimensional information in the first information processing device 200.

Note that the configuration of the second embodiment of the present disclosure can be applied to other embodiments. Specifically, the first information processing device 200 including the three-dimensional information holding unit 209 and the transmission data selection unit 210 in FIG. 13 can be applied to the first information processing device 200 according to the third embodiment of the present disclosure.

The configuration of the third embodiment of the present disclosure can be applied to other embodiments. Specifically, the second information processing device 400 including the camera 407 and the image data generation unit 408 in FIG. 14 can be applied to the second information processing device 400 according to the second embodiment of the present disclosure.

Note that the series of processing to be executed by individual devices described in the present specification may be implemented by using any of software, hardware, or a combination of software and hardware. The program constituting the software is stored in advance in, for example, a storage medium (non-transitory medium (or media)) provided inside or outside of each of devices. Then, each of programs is read into the RAM at the time of execution by the computer, for example, and is executed by a processor such as a CPU.

Furthermore, the processes described using the flowchart and the sequence diagram in the present specification do not necessarily have to be executed in the illustrated order. Some processing steps may be performed in parallel. In addition, additional processing steps may be employed, and some processing steps may be omitted.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

### Effects

The information processing system 10 includes the server device 300, the first information processing device 200, and the second information processing device 400. The server device 300 holds, out of three-dimensional information of a topography of a construction area including the shape of the disposed object, the three-dimensional information of the whole of the construction area, and updates the held three-dimensional information of the whole of the construction area based on local three-dimensional information which is the three-dimensional information of the area where the construction work has been conducted by a construction device in the construction area. The first information processing device 200 includes: the three-dimensional information generation unit 203 that generates local three-dimensional information based on position information of the construction device and an image of the construction area; and the three-dimensional information transmission unit 204 that transmits the generated local three-dimensional information to the server device 300. The second information processing device 400 generates the position information and transmits the generated position information to the first information processing device 200. This leads to an effect that the first information processing device 200 generates the local three-dimensional information based on the position information of the construction device generated by the second information processing device 400 and transmits the local three-dimensional information to the server device 300. This makes it possible to reduce the processing performed by the second information processing device 400.

In addition, the three-dimensional information generation unit 203 may generate the local three-dimensional information based on construction work information being information regarding a work state of the construction device, the position information, and the image of the construction area. This makes it possible to narrow down the construction area where the local three-dimensional information is to be generated according to the work state.

The three-dimensional information generation unit 203 may generate the local three-dimensional information using the image including the whole of the construction area as the image of the construction area.

Furthermore, the second information processing device 400 may further transmit an image of an area where the construction work has been conducted, and the three-dimensional information generation unit 203 may generate the local three-dimensional information using the transmitted image of the area where the construction work has been conducted as the image of the construction area. This makes it possible to generate detailed local three-dimensional information.

The three-dimensional information generation unit 203 can further generate the three-dimensional information of the whole of the construction area based on the image including the construction area. This makes it possible to generate and hold three-dimensional information of the whole of the construction area.

Furthermore, the first information processing device 200 may further include: a three-dimensional information holding unit 209 that holds the generated three-dimensional information of the whole of the construction area; and a selection unit (transmission data selection unit 210) that selects the local three-dimensional information based on the held three-dimensional information of the whole of the construction area. In addition, the three-dimensional information transmission unit 204 may transmit the selected local three-dimensional information to the server device 300. This makes it possible to reduce data communication volume.

The selection unit (transmission data selection unit 210) may select the local three-dimensional information based on a difference between the held three-dimensional information of the whole of the construction area and the generated local three-dimensional information. This makes it possible to update the three-dimensional information in accordance with the amount of the topographical change in the construction area.

Furthermore, the three-dimensional information generation unit 203 may generate the local three-dimensional information formed with point cloud data.

An information processing method is an information processing method including: holding, out of three-dimensional information of a topography of a construction area including a shape of a disposed object, the three-dimensional information of the whole of the construction area; generating position information of a construction device that conducts construction work in the construction area; generating local three-dimensional information that is the three-dimensional information of an area where the construction work has been conducted by the construction device based on the position information and an image of the construction area; and updating the held three-dimensional information of the whole of the construction area based on the generated local three-dimensional information. This makes it possible to reduce the processing.

The effects described in the present specification are merely examples, and thus, there may be other effects, not limited to the exemplified effects.

Note that the present technology can also have the following configurations.
(1) An information processing system comprising: a server device that holds, out of three-dimensional information of a topography of a construction area including a shape of a disposed object, the three-dimensional information of a whole of the construction area, and updates the held three-dimensional information of the whole of the construction area based on local three-dimensional information which is the three-dimensional information of an area where construction work has been conducted by a construction device in the construction area; a first information processing device including a three-dimensional information generation unit that generates the local three-dimensional information based on position information of the construction device and an image of the construction area and including a three-dimensional information transmission unit that transmits the generated local three-dimensional information to the server device; and a second information processing device that generates the position information and transmits the generated position information to the first information processing device.
(2) The information processing system according to the above (1), wherein the three-dimensional information generation unit generates the local three-dimensional information based on construction work information that is information of a work state of the construction device, the position information, and the image of the construction area.
(3) The information processing system according to the above (1) or (2), wherein the three-dimensional information generation unit generates the local three-dimensional information using the image including the whole of the construction area, as the image of the construction area.
(4) The information processing system according to one of the above (1) to (3), wherein the second information processing device further transmits an image of the area where the work has been conducted, and the three-dimensional information generation unit generates the local three-dimensional information using the transmitted image of the area where the work has been conducted, as the image of the construction area.
(5) The information processing system according to one of the above (1) to (4), wherein the three-dimensional information generation unit further generates the three-dimensional information of the whole of the construction area based on the image including the construction area.
(6) The information processing system according to the above (5), wherein the first information processing device further includes: a three-dimensional information holding unit that holds the generated three-dimensional information of the whole of the construction area; and a selection unit that selects the local three-dimensional information based on the held three-dimensional information of the whole of the construction area, and the three-dimensional information transmission unit transmits the selected local three-dimensional information to the server device.
(7) The information processing system according to the above (6), wherein the selection unit selects the local three-dimensional information based on a difference between the held three-dimensional information of the whole of the construction area and the generated local three-dimensional information.
(8) The information processing system according to one of the above (1) to (7), wherein the three-dimensional information generation unit generates the local three-dimensional information formed with point cloud data.
(9) An information processing method comprising: holding, out of three-dimensional information of a topography of a construction area including a shape of a disposed object, the three-dimensional information of a whole of the construction area; generating position information of a construction device that conducts work in the construction area; generating local three-dimensional information which is the three-dimensional information of an area where the work has been conducted by the construction device based on the position information and an image of the construction area; and updating the held three-dimensional information of the whole of the construction area based on the generated local three-dimensional information.
(10) An information processing system, comprising: a first processor configured to: receive location information indicating a location of a construction vehicle located within a construction site; receive local image data of an area around the construction vehicle, wherein the area around the construction vehicle comprises a portion of the construction site that is less than the entire construction site; generate local three-dimensional (3D) information based on the location information and the local image data; and output the local 3D information to a server; and the server, wherein the server stores global 3D information of the construction site including a topography of the entire construction site and wherein the server is configured to update the global 3D information of the construction site based on the local 3D information output by the first processor.
(11) The information processing system of the above (10), wherein the location information is obtained by a second processor mounted on the construction vehicle.
(12) The information processing system of any of the above (10) or (11), wherein the local image data is obtained by a second processor mounted on the construction vehicle.
(13) The information processing system of any of the above (10) to (12), wherein the local image data is obtained by an unmanned aerial vehicle.
(14) The information processing system of any of the above (10) to (13), wherein the global 3D information stored by the server is generated from image data captured by an unmanned aerial vehicle.
(15) The information processing system of any of the above (10) to (14), wherein the local 3D information is point cloud data.
(16) The information processing system of any of the above (11) to (12), wherein the first processor is further configured to: receive construction work information output from the second processor, the construction work information indicating work performed on an area of the construction site; and generate the local 3D information based on the construction work information.
(17) The information processing system of the above (16), wherein the first processor is further configured to: select at least a part of the local image data from the received local image data based on the construction work information; and generate the local 3D information based on the selected local image data.
(18) The information processing system of the above (17), wherein the first processor is configured to select the at least the part of the local image data when the construction work information includes dynamic work that changes a topography of the area of the construction site indicated by the construction work information.
(19) The information processing system of any of the above (10) to (18), wherein the first processor is further configured to store the global 3D information and select local 3D information based on the stored global 3D information.
(20) The information processing system of the above (19), wherein the first processor selects the local 3D information based on a determined difference between the stored global 3D information and the local 3D information.
(21) The information processing system of any of the above (10) to (20), wherein the first processor is further configured to: determine a construction area based on the location information; determine whether one or more other construction vehicles are within a threshold distance of the determined construction area; when it is determined that the one or more other construction vehicles are within the threshold distance of the determined construction area, combine respective construction areas corresponding to the one or more other construction vehicles with the determined construction area to form a combined construction area; and combine a plurality of local image data based on the combined construction area to form combined local image data.
(22) The information processing system of the above (21), wherein the first processor selects at least a part of the local image data from the combined local image data.
(23) The information processing system of the above (16), wherein the second processor is configured to obtain the local image data based on the construction work information.
(24) The information processing system of the above (23), wherein the second processor is configured to output the local image data to the first processor in response to a determination that the construction work information includes dynamic work that changes a topography of the area around the construction vehicle.
(25) The information processing system of any of the above (10) to (24), wherein the server is configured to output the updated global 3D information to a display device.
(26) A method for updating global three-dimensional (3D) information of a construction site comprising: receiving location information indicating a location of a construction vehicle located within the construction site; receiving local image data of an area around the construction vehicle, wherein the area around the construction vehicle comprises a portion of the construction site that is less than the entire construction site; generating local 3D information based on the location information and the local image data; transmitting the local 3D information to a server; and updating global 3D information of the construction site including a topography of the entire construction site stored by the server based on the local 3D information transmitted to the server.
(27) The method of the above (26), wherein updating the global 3D information comprises updating a portion of the global 3D information corresponding to the location of the construction vehicle.
(28) The method of the above (26), further comprising: receiving construction work information output from a second processor mounted on the construction vehicle, the construction work information indicating work performed on an area of the construction site; and generating the local 3D information based on the construction work information.
(29) At least one non-transitory computer-readable medium having instructions encoded thereon that, when executed by at least one processor, cause the at least one processor to perform a method for updating global three-dimensional (3D) information of a construction site, the method comprising: receiving location information indicating a location of a construction vehicle located within the construction site; receiving local image data of an area around the construction vehicle, wherein the area around the construction vehicle comprises a portion of the construction site that is less than the entire construction site; generating local 3D information based on the location information and the local image data; transmitting the local 3D information to a server; and updating global 3D information of the construction site including a topography of the entire construction site stored by the server based on the local 3D information transmitted to the server.

### REFERENCE SIGNS LIST

10 Information processing system
100 Third information processing device
104, 402 Position information generation unit
109, 405 Transmission unit
200 First information processing device
203 Three-dimensional information generation unit
204 Three-dimensional information transmission unit
207 Construction area determination unit
209 Three-dimensional information holding unit
210 Transmission data selection unit
300 Server device
302 Three-dimensional information update unit
303 Three-dimensional information holding unit
400, 400a, 400b, 400c Second information processing device
403 Vehicle state information acquisition unit
408 Image data generation unit
500 Display terminal

1. An information processing system, comprising:
a first processor configured to:
receive location information indicating a location of a construction vehicle located within a construction site;
receive local image data of an area around the construction vehicle, wherein the area around the construction vehicle comprises a portion of the construction site that is less than the entire construction site;
generate local three-dimensional (3D) information based on the location information and the local image data; and
output the local 3D information to a server; and
the server, wherein the server stores global 3D information of the construction site including a topography of the entire construction site and wherein the server is configured to update the global 3D information of the construction site based on the local 3D information output by the first processor.

2. The information processing system of claim 1, wherein the location information is obtained by a second processor mounted on the construction vehicle.

3. The information processing system of claim 1, wherein the local image data is obtained by a second processor mounted on the construction vehicle.

4. The information processing system of claim 1, wherein the local image data is obtained by an unmanned aerial vehicle.

5. The information processing system of claim 1, wherein the global 3D information stored by the server is generated from image data captured by an unmanned aerial vehicle.

6. The information processing system of claim 1, wherein the local 3D information is point cloud data.

7. The information processing system of claim 2, wherein the first processor is further configured to:
receive construction work information output from the second processor, the construction work information indicating work performed on an area of the construction site; and
generate the local 3D information based on the construction work information.

8. The information processing system of claim 7, wherein the first processor is further configured to:
select at least a part of the local image data from the received local image data based on the construction work information; and
generate the local 3D information based on the selected local image data.

9. The information processing system of claim 8, wherein the first processor is configured to select the at least the part of the local image data when the construction work information includes dynamic work that changes a topography of the area of the construction site indicated by the construction work information.

10. The information processing system of claim 1, wherein the first processor is further configured to store the global 3D information and select local 3D information based on the stored global 3D information.

11. The information processing system of claim 10, wherein the first processor selects the local 3D information based on a determined difference between the stored global 3D information and the local 3D information.

12. The information processing system of claim 1, wherein the first processor is further configured to:
determine a construction area based on the location information;
determine whether one or more other construction vehicles are within a threshold distance of the determined construction area;
when it is determined that the one or more other construction vehicles are within the threshold distance of the determined construction area, combine respective construction areas corresponding to the one or more other construction vehicles with the determined construction area to form a combined construction area; and
combine a plurality of local image data based on the combined construction area to form combined local image data.

13. The information processing system of claim 12, wherein the first processor selects at least a part of the local image data from the combined local image data.

14. The information processing system of claim 7, wherein the second processor is configured to obtain the local image data based on the construction work information.

15. The information processing system of claim 14, wherein the second processor is configured to output the local image data to the first processor in response to a determination that the construction work information includes dynamic work that changes a topography of the area around the construction vehicle.

16. The information processing system of claim 1, wherein the server is configured to output the updated global 3D information to a display device.

17. A method for updating global three-dimensional (3D) information of a construction site comprising:
receiving location information indicating a location of a construction vehicle located within the construction site;
receiving local image data of an area around the construction vehicle, wherein the area around the construction vehicle comprises a portion of the construction site that is less than the entire construction site;
generating local 3D information based on the location information and the local image data;
transmitting the local 3D information to a server; and
updating global 3D information of the construction site including a topography of the entire construction site stored by the server based on the local 3D information transmitted to the server.

18. The method of claim 17, wherein updating the global 3D information comprises updating a portion of the global 3D information corresponding to the location of the construction vehicle.

19. The method of claim 17, further comprising:
receiving construction work information output from a second processor mounted on the construction vehicle, the construction work information indicating work performed on an area of the construction site; and
generating the local 3D information based on the construction work information.

20. At least one non-transitory computer-readable medium having instructions encoded thereon that, when executed by at least one processor, cause the at least one processor to perform a method for updating global three-dimensional (3D) information of a construction site, the method comprising:
receiving location information indicating a location of a construction vehicle located within the construction site;
receiving local image data of an area around the construction vehicle, wherein the area around the construction vehicle comprises a portion of the construction site that is less than the entire construction site;
generating local 3D information based on the location information and the local image data;
transmitting the local 3D information to a server; and
updating global 3D information of the construction site including a topography of the entire construction site stored by the server based on the local 3D information transmitted to the server.
